(19) United States
(12) Patent Application Publication
(10) Pub. No.: US 2012/0047138 A1
(43) Pub. Date: Feb. 23, 2012

(54) CONTENT FILE CLASSIFYING APPARATUS AND CONTENT FILE CLASSIFYING METHOD

(76) Inventor: Katsumi AKAGI, Osaka (JP)

(21) Appl. No.: 13/192,524

(22) Filed: Jul. 28, 2011

(30) Foreign Application Priority Data
Aug. 19, 2010 (JP) 2010-183583
Mar. 16, 2011 (JP) 2011-058293

(51) Int. Cl. G06F 17/30

(52) U.S. Cl. 707/736; 707/E17.014

(57) ABSTRACT

A content file classifying apparatus includes the following: an obtaining unit obtaining content files; a classifying unit generating, based on additional information on each of the content files obtained by the obtaining unit, classification information showing a category to which each content file belongs; a control unit controlling recording of the content files on a recording medium; and a recording unit recording each of the content files on the recording medium according to the control by the control unit, wherein the control unit causes the recording unit to (i) create, on the recording medium, folders corresponding to categories shown in the classification information, and (ii) record each of the content files in at least one of the folders corresponding to a category to which the content file belongs.

### BACKGROUND OF THE INVENTION

(1) Field of the Invention

The present invention relates to a content file classifying apparatus which classifies content files.

(2) Description of the Related Art

There are conventional apparatuses capable of retrieving desired data from among a large number of content files.

For example, Patent Reference 1 (Japanese Unexamined Patent Application Publication No. 2008-041155) discloses a display control device which (i) categorizes content files on the basis of the retrieval conditions that are based on additional information, such as tag information, and (ii) displays the images, used in a retrieval operation, that are arranged on a plane.

Specifically, Patent Reference 1 discloses an embodiment which involves retrieving the tag information for all the content files recorded on the content recording unit, and generating the images used in a retrieval operation.

### SUMMARY OF THE INVENTION

The display control device disclosed in Patent Reference 1 suffers a problem; the user finds it difficult to locate in which folder in the content recording unit records a desired content file when the user intends to directly access to the content file in the case where no search window is opened. Accordingly, the conventional display control device is not useful for the user.

The present invention is conceived in view of the above problem and has as an object to introduce a content file classifying apparatus which effectively classifies content files and records the content files in a recording medium.

In order to achieve the above object, a content file classifying apparatus according to an aspect of the present invention includes: an obtaining unit which obtains content files; a classifying unit which generates, based on additional information on each of the content files obtained by the obtaining unit, classification information showing a category to which each content file belongs; a control unit which controls recording of the content files on a recording medium; and a recording unit which records each of the content files on the recording medium according to the control by the control unit, wherein the control unit causes the recording unit to (i) create, on the recording medium, folders corresponding to categories shown in the classification information generated by the classifying unit, and (ii) record each of the content files in at least one of the folders corresponding to a category to which the content file belongs.

This structure allows (i) the content files to be classified based on respective pieces of additional information, and (ii) folders to be created under respective categories. Each of the content files is stored in the folder corresponding to the category to which the content file belongs.

Assume the case, for example, where the content files are allocated among and stored in various folders on the recording medium, regardless of pieces of additional information attached to the respective content files. Here the content file classifying apparatus according to the aspect can move or copy each of the content files to an actual folder corresponding to a category to which each of the content files belongs. Hence, for example, the user can directly access a desired content file with ease.

Furthermore, when a single process is executed on content files under a single category, the process can be executed at a time on a folder basis. In other words, the content files are efficiently processed.

Accordingly, the content file classifying apparatus can effectively classify content files and record the files on a recording medium.

In the content file classifying apparatus according to another aspect of the present invention, the classifying unit may generate the classification information showing a tree structure constructed of the categories based on the additional information on each of the content files, and the control unit may cause the recording unit to create the folders so that the folders are organized in the tree structure shown in the classification information.

This structure makes possible generating hierarchized folders according to the tree structure of categories. This allows the user to, for example, efficiently access his or her desired content file. In the content file classifying apparatus according to another aspect of the present invention, when receiving a predetermined command for generating the folders, the control unit may causes the recording unit to (i) create the folders on the recording medium, and (ii) record each of the content files in at least one folder, from among the folders, corresponding to a category to which the content file belongs.

According to this operation, the content file classifying apparatus according to the aspect can store each of content files in a folder under a corresponding category in any given timed relationship determined by the user.

In the content file classifying apparatus according to another aspect of the present invention, the classifying unit may generate or update the additional information on at least one of the content files according to a command which said classifying unit receives.

According to this operation, the classifying unit can add to each of the content files the additional information as information which is difficult to be automatically attached. As a result, the content file classifying apparatus can classify the content files more effectively.

In the content file classifying apparatus according to another aspect of the present invention, the classifying unit may further update the classification information according to a command which the classifying unit receives, and, when the classifying unit adds a new category to the classification information, the control unit may further cause the recording unit to create, on the recording medium, a new folder corresponding to the new category.

When any given new category is designated, this operation allows the classifying unit to update an actual folder structure used for storing the content files to a structure reflected in the addition of the new category.

In the content file classifying apparatus according to another aspect of the present invention, the classifying unit may further update the classification information according to a command which the classifying unit receives, and, when the classifying unit deletes a category from the classification information, the control unit may further cause the recording unit to delete a folder corresponding to the deleted category.

When an existing category is deleted, this operation allows the classifying unit to update an actual folder structure used for storing the content files to a structure reflected in the deletion of the category.

In the content file classifying apparatus according to another aspect of the present invention, the classifying unit may further update the classification information according to a command which the classifying unit receives, and, when the classifying unit deletes a category from the classification information, the control unit may further cause the recording unit to move one or more content files, stored in a folder corresponding to the deleted category, from the folder to an other folder.

When an existing category is deleted, this operation allows the classifying unit to update an actual folder structure used for storing the content files to a structure reflected in the deletion of the category.

In the content file classifying apparatus according to another aspect of the present invention, the classifying unit may further update the classification information according to a command which the classifying unit receives, so that one of the content files corresponds to an other category which differs from a category shown in additional information on the one content file, and the control unit may further cause the recording unit to record the one content file in a folder corresponding to the other category according to the updated classification information.

This operation allows the classifying unit to associate “Content file A” classified by the classifying unit's determination under “Category a” with “Category b” based on the user's determination. Furthermore, the classifying unit can change the actual storage location of “Content file A” according to the update result of the association.

In the content file classifying apparatus according to another aspect of the present Invention, the obtaining unit may further obtain a new content file, the classifying unit may further update the classification information using additional information on the new content file, and when the classifying unit adds a new category to the classification information, and the control unit may further cause the recording unit to (i) create, on the recording medium, a new folder corresponding to the new category, and (ii) record the new content file in the new folder.

Even though a content file is added to the recording medium, this operation allows the content file to (i) correspond to a category which is based on the additional information on the content file itself, and (ii) be stored in a folder corresponding to the category.

In the content file classifying apparatus according to another aspect of the present invention, the obtaining unit may obtain the content files which have been found in the recording medium before the control unit creates the folders.

According to the operation, the content file classifying apparatus can store in a folder each of a large number of content files recorded on the recording medium, for example. Here the folder is created on the recording medium under a category shown in the additional information on each content file.

As a result, for example, the management of the content files in numbers can be simplified.

In the content file classifying apparatus according to another aspect of the present invention, when one of the content files belongs to two or more categories shown in the classifying information, the control unit may cause the storage unit to store the one content file to each of two or more folders under the two or more categories.

This operation allows a single content file, which belongs to two or more categories, to be stored in each of the folders that are corresponding to the categories. In other words, the actual data on the single content file is stored in those folders, so that a process which each content file undergoes can be executed without fail.

The present invention may also be introduced in a form of a content file classifying method including a characteristic process executed by the content file classifying apparatus according to any of the above aspects of the present invention.

Furthermore, the present invention may be utilized in a form of a program product which, when loaded into a computer, causes the computer to execute various processes included in the content file classifying method, and a recording medium on which the program is recorded. In addition, the present invention may distribute the program via a transmission medium such as the Internet and a recording medium such as a digital versatile disk (DVD).

Furthermore, the present invention may be introduced in a form of an integrated circuit including some or all of the constituent units of the content file classifying apparatus according to the aspect of the present invention.

The present invention introduces a content file classifying apparatus for effectively classifying content files and recording the content files on a recording medium.

### FURTHER INFORMATION ABOUT TECHNICAL BACKGROUND TO THIS APPLICATION

The disclosures of Japanese Patent Applications No. 2010-183583 filed on Aug. 19, 2010 and No. 2011-58293 filed on Mar. 16, 2011 including specifications, drawings and claims are incorporated herein by reference in their entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 shows a main hardware structure of a personal computer (PC) according to Embodiment;

FIG. 2 is a block diagram showing a main functional structure of the PC according to Embodiment;

FIG. 3 exemplifies a data structure of an image file to be classified by the PC according to Embodiment;

FIG. 4 exemplifies a data structure of virtual folder structure information according to Embodiment;

FIG. 5 schematically shows an editing window on which the PC according to Embodiment causes a liquid crystal display (LCD) to provide;

FIG. 6 is a flowchart showing a flow of a basic process executed on the PC according to Embodiment; and

FIG. 7 schematically shows a synchronous operation of an actual folder structure to a virtual folder structure according to Embodiment.

### DESCRIPTION OF THE PREFERRED EMBODIMENTS

Hereinafter, a structure and an operation of the PC 100 according to Embodiment shall be described with reference to the drawings.

### 1. Structure of the PC 100

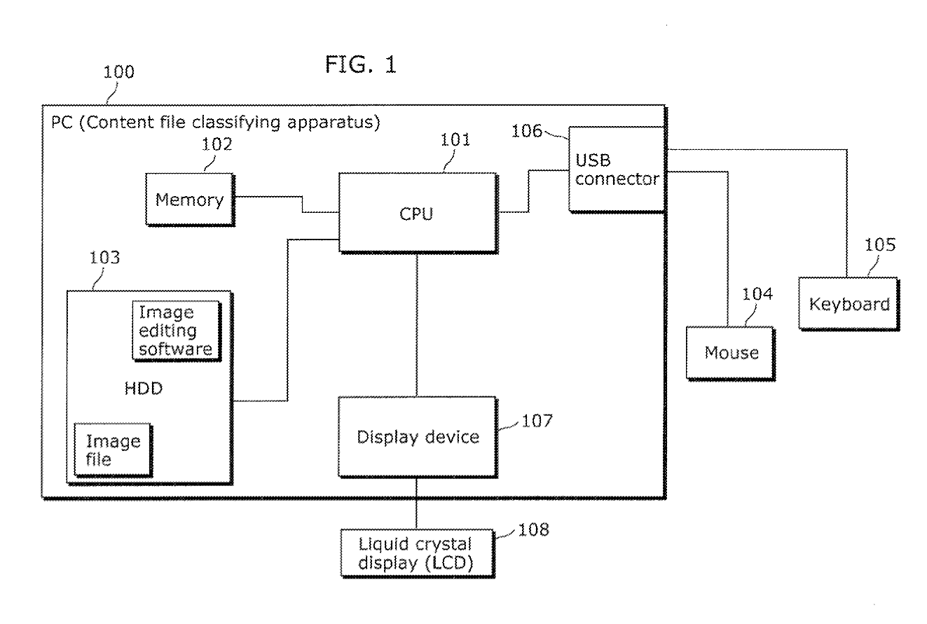

Described first is a hardware structure of the PC 100 with reference to FIG. 1.

FIG. 1 shows the main hardware structure according to Embodiment.

The PC 100 exemplifies a content file classifying apparatus in an implementation of the present invention. The PC 100 includes a Central Processing Unit (CPU) 101, a memory 102, a Hard Disk Drive (HDD) 103, a Universal Serial Bus (USB) connector 106, and a display device 107. The PC 100 connects to a mouse 104, a keyboard 105; and a Liquid Crystal Display (LCD) 108.

The CPU 101 executes various kinds of information processing. The CPU 101 electrically connects to the memory 102, the HDD 103, the display device 107, and the USB connector 106.

The CPU 101 can change windows displayed on the LCD display 108 via the display device 107. The CPU 101 also receives a user's command from the mouse 104 and the keyboard 105 via the USB connector 106.

Although not shown, the CPU 101 has total control over a power system supplying powers to each of the units in the PC 100.

The memory 102 temporarily stores information which the CPU 101 requires to execute various kinds of processing. In the memory 102, the CPU 101 stores virtual folder structure information generated based on additional information in an image file recorded on the HDD 103.

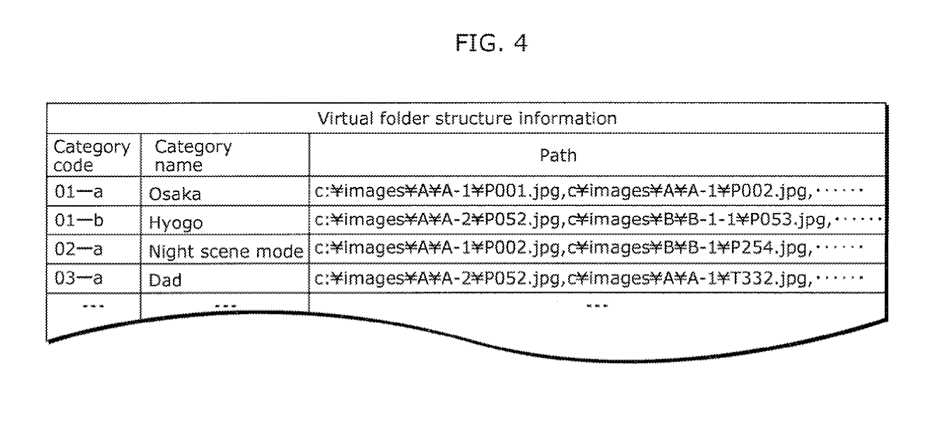

The virtual folder structure information exemplifies classification information used for the content file classifying apparatus in the implementation of the present invention. Details of the virtual folder structure information shall be described later with reference to FIG. 4.

The HDD 103 is a high-capacity disk drive recording image files such as content files. The HDD 103 has a set of folders used for mainly storing image files.

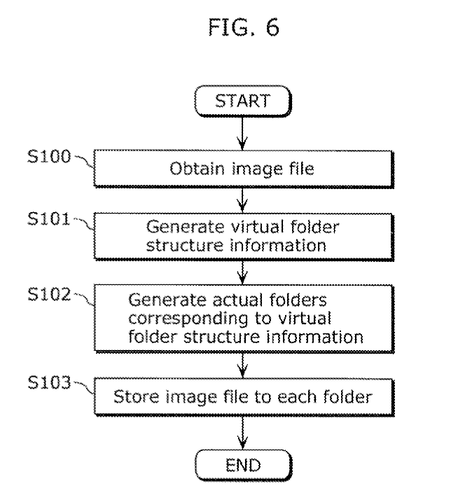

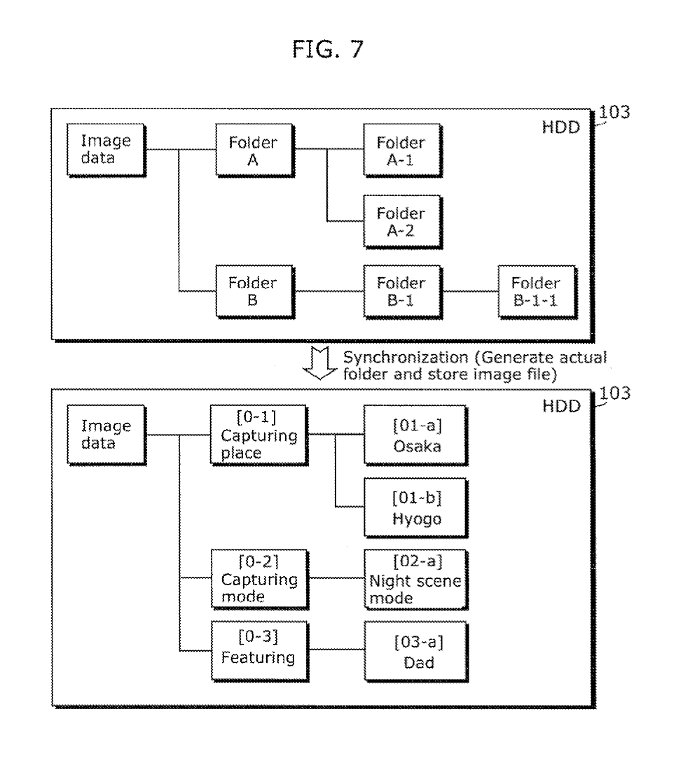

Specifically, the set including the folders is created over an after-described procedure carried out by the PC 100 with reference to FIG. 6. The set of folders is in a hierarchical form based on a predetermined classification. Each of the folders in the hierarchy stores an image file which belongs to the classification of the folder.

The predetermined classification may include a classification according to capturing time and date, a manufacturer of a digital camera which has captured the image, and the model of the camera. The CPU 101 can also structure or update the set of folders storing the image files on the HDD 103 based on a virtual folder structure obtained by classifying the image files. The details of the process shall be described later.

In addition, the HDD 103 stores an executable file for the image editing software. According to the user's command to activate the image editing software, the CPU 101 opens the executable file recorded on the HDD 103 in the memory 102. This operation allows the CPU 101 to execute various kinds of processing of the image editing software.

The mouse 104 is a pointing device which the user operates for editing (hereinafter referred to as “editing operation”) a virtual file structure. On the window provided by the image editing software, the user can select and move an image file with the mouse 105.

The keyboard 105 is a device through which the user enters characters.

The USB connector 106 connects the mouse 104 and the keyboard 105 to the PC 100.

The display device 107 visually-images window information calculated by the CPU 101, and transmits the window information to the LCD 108.

The LCD 108 displays the window information visually-imaged by the display device 107.

As described above, the CPU 101 reads the image editing software from the HDD 103, and records the software on the memory 102. Then the CPU 101 activates to execute the image editing software. According to a program included in the image editing software, in addition, the CPU 101 executes the following process:
(i) Execute arithmetic processing;
(ii) Read information from the memory 102;
(iii) Store the information in the memory 102;
(iv) Read the image file recorded on the HDD 103;
(v) Store the image file on the HDD 103;
(vi) Receive the user's editing operation, executed with the mouse 105 and the keyboard 106, via the USB connector 106;
(vii) Transmit the window information to the display device 107; and
(viii) Structure and update the set of folders storing the image files on the HDD 103 based on the virtual folder structure.

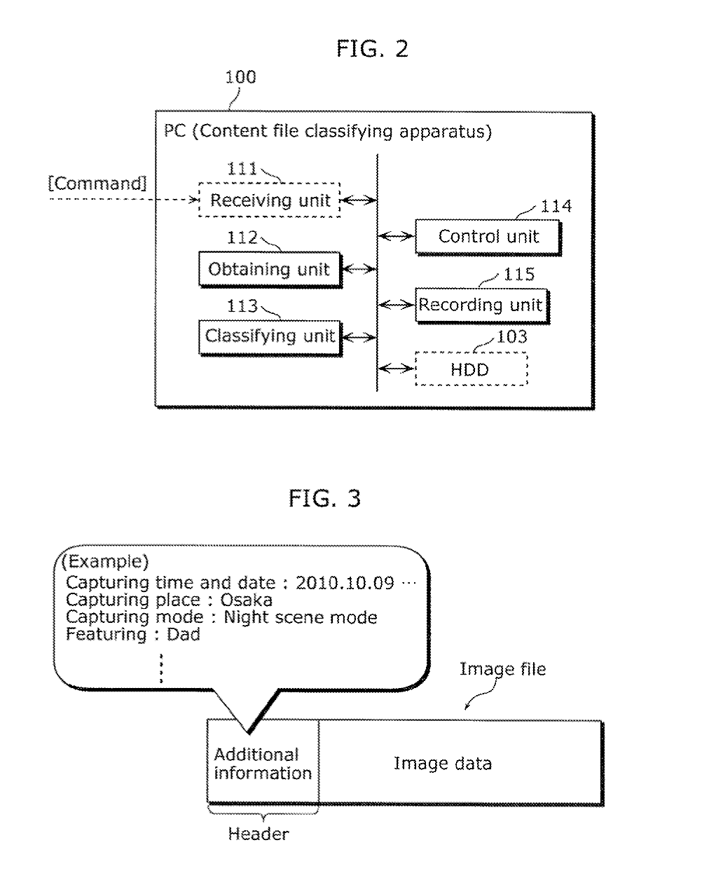

Described next is a functional structure of the PC 100 according to Embodiment with reference to FIG. 2.

FIG. 2 is a block diagram showing a main functional structure of the PC 100 according to Embodiment.

As shown in FIG. 2, the PC 100 according to Embodiment includes the following main functional units: an obtaining unit 112, a classifying unit 113, a control unit 114, and a recording unit 115.

The obtaining unit 112 obtains two or more content files. Based on additional information on each of the content files obtained by the obtaining unit 112, the classifying unit 113 generates the virtual folder structure information showing a category to which each of the content files belongs.

The control unit 114 controls the recording of the content files on the HDD 103. According to the control by the control unit 114, the recording unit 115 records each of the content files on the HDD 103.

Specifically, the control unit 114 causes the recording unit 115 to create, on the HDD 103, folders corresponding to categories shown in the virtual folder structure information generated by the classifying unit 113. In addition, the control unit 114 causes the recording unit 115 to record each content file in at least one of the folders corresponding to a category to which the content file belongs.

In Embodiment, the PC 100 further includes a receiving unit 111. The receiving unit 111 receives a user's command sent to the classifying unit 113 and the control unit 114.

It is noted that, in Embodiment, the functions of the obtaining unit 112, the classifying unit 113, the control unit 114, and the recording unit 115 are carried out by the CPU 101 executing the image editing software.

In Embodiment, the function of the receiving unit 111 is carried out by the USB connector 106 and through information processing by the CPU 101.

Furthermore, the functional blocks shown in FIG. 2 may be formed as one or more integrated circuits.

### 2. An Example of Data Structure of Various Kinds of Information

Described next is a data structure example of various kinds of information which the PC 100 according to Embodiment manipulates with reference to FIGS. 3 and 4.

FIG. 3 exemplifies a data structure of an image file to be classified by the PC 100 according to Embodiment.

As shown in FIG. 3, the image file according to Embodiment includes image data and additional information.

Stored in a header of the image file, the additional information includes various kinds of attribute information of the image data.

As the additional information, each piece of the following information is exemplified as shown in FIG. 3: “Capturing time and date”, “Capturing place”, “Capturing mode”, and “Featuring”. As a matter of course, the additional information may include information other than the above, such as “model information” on the model of the camera which captures the object.

“Capturing time and date” shows information on the time and date when the image data was generated. “Capturing place” shows information on the place where the object was captured to obtain the image data.

It is noted that, as the information showing the capturing place, Global Positioning System (GPS) information (latitude and longitude) may be included in the additional information instead of the name of the place. Here, for example, a digital camera generating the image data or the PC 100 may use the latitude and the longitude to provide information on the area of the latitude and the longitude.

“Capturing mode” shows information on a capturing mode of, for example, the digital camera in generating the image data. “Capturing mode” includes “Night scene mode” in FIG. 3, as well as “Auto Mode” and “Landscape mode”.

“Featuring” shows information on an object in the image shown in the image data. For example, the user may watch the image shown in the image data to specify an object found in the image, and enter the object as “Featuring” via the keyboard 105. Furthermore, for example, a digital camera generating the image data or the PC 100 may analyze the image data, and cross-check the analysis result using the object data base to create “Featuring”.

In Embodiment, the classifying unit 113 classifies the image files based on each piece of additional information on corresponding one of the image files. According to the classification results, the classifying unit 113 generates, for example, the virtual folder structure information shown in FIG. 4.

FIG. 4 exemplifies a data structure of the information on a virtual folder structure according to Embodiment.

As FIG. 4 shows, the virtual folder structure information according to Embodiment includes as data Items “Category code”, “Category name”, and “Path”.

“Category code” is information for identifying each of categories obtained through the classification, as well as a data item showing a tree structure of a category. Specifically, in each “Category code”, a number before “-” (hyphen) is an upper level category. An alphabet following “-” is a lower level category.

In a category code “01-a”, for example, “01” indicates an upper level category “Capturing place”, and “a” following “01” indicates “Osaka” which belongs to “Capturing place”.

“Category name” is a data item indicating the name of each category. “Path” is a data item indicating a path of an image file which belongs to each category.

It is noted that the after-described FIG. 6 will show in details how the CPU 101 working as the classifying unit 113 generates the virtual folder structure information.

When causing the LCD 108 to provide an editing window, the PC 100 displays a virtual folder structure which is based on the virtual folder structure information shown, for example, in FIG. 4.

### 3. Editing Window Overview

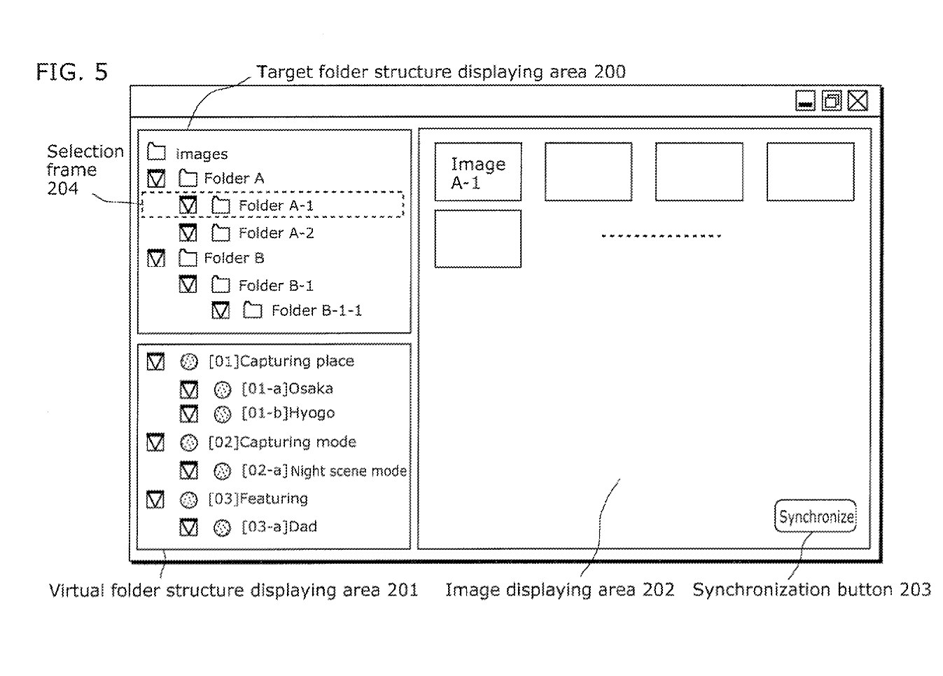

Described next is an overview of an editing window provided on the LCD 108 with reference to FIG. 5.

FIG. 5 schematically shows the editing window on which the PC 100 according to Embodiment causes the LCD 108 to provide.

As shown in FIG. 5, the editing window according to Embodiment includes the following: a target folder structure displaying area 200 showing a folder structure (an actual folder structure) on the HDD 103, a virtual folder structure displaying area 201 showing a virtual folder structure, an image displaying area 202, a synchronization button 203, and a selection frame 204.

The target folder structure displaying area 200 displays a hierarchical structure of a set of folders recorded on the HDD 103. The set of folders holds image files to be classified.

As shown in FIG. 5, the target folder structure displaying area 200 displays an actual folder structure classified in hierarchical levels under, for example, Folder A, Folder A-1, Folder A-2, Folder B, Folder B-1, and Folder B-1-1. Here the image files in the actual folder structure are recorded on the HDD 103.

It is noted that the folder structure displayed in the target folder structure displaying area 200 may be the entire folder structure which is found on the HDD 103 and is holding the image files, or may be a structure of some of folders holding the image files.

The user operates the mouse 104 or the keyboard 105 to select a folder included in the folder structure displayed in the target folder structure displaying area 200. To show the user that the folder has been selected, the selected folder has the selection frame 204 superimposed thereon.

It is noted that the receiving unit 111 receives operation information to be used as a command from the user and entered into the PC 100 with the mouse 104 and the keyboard 105.

The virtual folder structure displaying area 201 is a frame for displaying a virtual folder structure. Here the virtual folder structure virtually folder-structures the image files recorded on the HDD 103 based on the additional information.

As shown in FIG. 3, each image file is recorded with additional information attached. On the editing window shown in FIG. 5, the CPU 101 displays on the virtual folder structure displaying area 201 the result of classifying the image files based on the recorded additional information which is associated with each image file.

Specifically, the virtual folder structure displaying area 201 displays a tree-structured virtual set of folders created based on, for example, the virtual folder structure information shown in FIG. 4.

As a result, as shown in FIG. 5, the virtual folder structure displaying area 201 displays the following data items: [01] Capturing place, [01-a] Osaka, [01-b] Hyogo, [02] Capturing mode, [02-a] Night scene mode, [03] Featuring, and [03-a] Dad.

In other words, the hierarchically-classified virtual folder structure is displayed in the virtual folder structure displaying area 201. Here the virtual folder structure virtually shows the result of classification based on each piece of additional information for a corresponding one of the image files recorded on folders shown in the target folder structure displaying area 200.

The user operates the mouse 104 or the keyboard 105 to select a folder included in the folder structure displayed in the virtual folder structure displaying area 201. To show the user that the folder has been selected, the selected folder has the selection frame 204 superimposed thereon.

The image displaying area 202 is a frame for displaying an image included in a folder. Here the folder has the selection frame 204 superimposed thereon and thus has been under the selection state in the target folder structure displaying area 200 or in the virtual folder structure displaying area 201.

When the folder A-1, found in the target folder structure displaying area 200, has the selection frame 204 superimposed thereon and thus has been under the selection state as shown in FIG. 5, the image displaying area 202 displays an image stored in the folder A-1.

When the user selects a virtual folder [01-b] Hyogo, for example, the image displaying area 202 displays an image file in a category “Hyogo” (See FIG. 4).

In addition, the user operates the mouse 104 or the keyboard 105 to select an image displayed in the image displaying area 202.

It is noted that the additional information which each image file may include information over two more different categories.

As shown in FIG. 3, for example, assume the case where the image file has additional information including the capturing mode information “Night scene mode”, and the capturing place information “Osaka”.

Here the image file is virtually classified with both of the categories “Night scene mode” and “Osaka”. In other words, the classifying unit 113 can redundantly store the image file, so that the image files are classified under different categories based on the additional information.

In addition, there can be an image file with no additional information attached. Here the classifying unit 113 classifies the image file with the category “Miscellaneous”. As a result, the virtual folder structure displaying area 201 displays, for example, a folder with “[99] Miscellaneous” in the same hierarchical level as “[01] to Capturing place”.

### 4. Process Executed by the PC 100

FIG. 6 is a flowchart showing a flow of a basic process executed by the PC 100 according to Embodiment.

With FIG. 6, described hereinafter shall be a process executed by each of the functional constituent features, such as the CPU 101, (See FIG. 2) of the PC 100 in Embodiment as well as the basic process executed by the PC 100.

First, the obtaining unit 112 obtains two or more image files from the HDD 103 (S100). Specifically, the obtaining unit 112 obtains an image file stored in each of the folders displayed in the target folder structure displaying area 200 (See FIG. 5). It is noted that the obtaining unit 112 does not have to obtain the image files at a time; instead, one or more of the image files may be sequentially obtained as necessary.

Based on the additional information for each of the image files, the classifying unit 113 generates virtual folder structure information indicating a category to which each of the image files belongs (S101).

When generating the information, specifically, the classifying unit 113 reads the stored additional information associated with each of the image files obtained by the obtaining unit 112, and stores the read additional information in the memory 102.

Furthermore, the classifying unit 113 reads the path indicating a location of each image file on the HDD 103, and records on the memory 102 the read path along with the associated additional information. For example, suppose the case where an image file A has the “Night scene mode” and “Osaka” as additional information, and another image file B has the “Night scene mode” and “Hyogo” as additional information.

Here, the category “Night scene mode” (for example, the category “02-a” shown in FIG. 4) is associated with the paths of the image files A and B. Then the associated paths are recorded on the memory 102.

In the category “Osaka” (for example, the category “01-a” shown in FIG. 4), the additional information for the image file A is associated with the path of the image file A. Then the additional information and the associated path are recorded on the memory 102. Furthermore, the category “Hyogo” (for example, the category “01-b” shown in FIG. 4) is associated with the path of the image file B. Then the associated path is recorded on the memory 102.

As described above, the classifying unit 113 associates each of the categories which is based on the additional information with the path of the relevant image file, and records the category and the associated path on the memory 102.

Each of the categorized piece of information recorded on the memory 102 is held in the memory 102, for example, as the table-formed virtual folder structure information as shown in FIG. 4.

It is noted that the classifying unit 113 can obtain and renew the additional information recorded on the memory 102. Hence the classifying unit 113 can obtain and renew the virtual folder structure information recorded on the memory 102.

Based on the obtained virtual folder structure information and the renewed virtual folder structure information, the CPU 101 can display the virtual set of folders in the virtual folder structure displaying area 201.

The control unit 114 causes the recording unit 115 to create, on the HDD 103, folders (actual folders) corresponding to respective categories indicated in the virtual folder structure information (S102).

The control unit 114 further causes the recording unit 115 to record each of the image files in at least one folder among from the folders. The folder corresponds to the category to which the image file belongs.

Here the generation of the actual folders (S102) and the storage of the image file in the actual folder (S103) are carried out when the user selects the synchronization button 203 in Embodiment 1.

In other words, the synchronization button 203 is used to synchronize the actual folder structure on the HDD 103 with the virtual folder structure displayed on the editing window.

The synchronization button 203 can be selected through the mouse 104 or the keyboard 105. When the synchronization button 203 is selected, the CPU 101 working as the receiving unit 111 receives the selection information indicating that the synchronization button 203 has been selected. It is noted that the selection information exemplifies a predetermined command for generating the folders.

When the receiving unit 111 receives the selection information, the control unit 114 causes the recording unit 115 to construct the actual folder structure on the HDD 103 based on the virtual folder structure displayed in the virtual folder structure displaying area 201.

The control unit 114 further causes the recording unit 115 to record an image file corresponding to each of the folders included in the actual folder structure constructed on the HDD 103.

When the control unit 114 constructs an actual folder structure synchronized with a virtual folder structure, the set of folders displayed in the target folder structure displaying area 200 may be left as it is.

Here image files, stored in each of the left actual set of folders, are held as they are. Each copy of the image files is stored in a newly-created actual folder corresponding to the category of the image file.

This operation prevents an image file from being accidentally deleted.

Furthermore, the control unit 114 may change the structure of the actual set of folders displayed in the target folder structure displaying area 200 in order to construct an actual folder structure synchronized with a virtual folder structure.

This operation allows, for example, an efficient use of the storage area in the HDD 103.

Described next is the case where the user arbitrarily edits the classification of the virtual folder structure on the editing window.

With the mouse 104 or the keyboard 105, the user drags and drops desired files (for example, an image A-1) displayed in the image displaying area 202 onto a folder in a desired category (for example, [01-a] Osaka) included in the virtual folder structure displaying area in 201, so that the user can classifies the files.

In the case where the user does not like the classification result based on the additional information of the image file, the user can freely change an association between the image file and the category.

In other words, according to a command which the receiving unit 111 receives, the classifying unit 113 updates the virtual folder structure information so that the association is changed as described above.

When the user finishes editing the classification (in other words, the user finishes manually associating each image file with a category), the user operates the mouse 104 or the keyboard 105 to select the synchronization button 203. When the synchronization button 203 is selected, the control unit 114 causes the recording unit 115 to construct an actual folder structure on the HDD 103 according to the virtual folder structure displayed in the virtual folder structure displaying area 201.

The control unit 114 further causes the recording unit 115 to record an image file corresponding to each of the folders included in the folder structure constructed on the HDD 103.

FIG. 7 schematically shows a synchronous operation of an actual folder structure to a virtual folder structure.

The drawing on the top shows an actual folder structure in the HDD 103 before synchronization. When the user selects the synchronization button 203, the control unit 114 causes the recording unit 115 to actually construct a folder structure on the HDD 103 according to the virtual folder structure.

Then the control unit 114 causes the recording unit 115 to record an image file corresponding to each of the folders included in the actual folder structure constructed on the HDD 103.

The drawing on the bottom shows an actual folder structure in the HDD 103 after synchronization. Hence, the control unit 114 constructs the actual folder structure according to the classification result which is based on additional information of each image file. Thus even though the editing window is not displayed, the user can easily understand that his or her desired image file is stored in which folder when the user desires to directly access the desired image file in the HDD 103.

Assume, for example, the case where two or more image files are recorded on the HDD 103 regardless of the details of each piece of additional information. Here, consider the case where the user desires to view an image file captured using one of the capturing modes; namely “Night scene mode”, after the above synchronous operation; the user opens the folder named “Capturing mode”, and opens the folder named “Night scene mode”, so that the user can directly access the image file captured with “Night scene mode”.

In other words, when the user desires to access an image file which belongs to a category, the user traces the tree formed of two or more categories. Thus the user can easily arrive at a folder corresponding to the category.

Moreover, for example, consider the case where the user desires to provide processing, such as image re-sizing, to all the image files which belong to “Night scene mode”. Here all the image files are stored in one folder under “Night scene mode” after the above synchronous operation. Thus the user can provide the processing to the image file at a time.

### 5. Conclusion

As described above, the PC 100 according to Embodiment includes the following: the obtaining unit 112 which obtains content files, the classifying unit 113 which generates, based on additional information on each of the content files obtained by the obtaining unit 112, the virtual folder structure information showing a category to which each content file belongs, the control unit 114 which controls recording of the content files on the HDD 103, and the recording unit 115 which records each of the content files on the recording medium according to the control by the control unit 114. Here the control unit 114 causes the recording unit 115 to (i) create, on the HDD 103, folders corresponding to categories shown in the virtual folder structure information generated by the classifying unit 113, and (ii) record each of the content files in at least one of the folders corresponding to a category to which the content file belongs.

Hence the PC 100 can create a folder on the HDD 103 based on the additional information on the obtained image file. Specifically, the PC 100 can effectively classify and store image files. In other words, the PC 100 can classify the image files recorded on the HDD 103, so that the classified image files are easy to use for the user.

In the PC 100 according to Embodiment, the classifying unit 113 generates the virtual folder structure information showing a tree structure constructed of the categories based on the additional information on each of the content files, and the control unit 114 may cause the recording unit 115 to create the folders so that the folders are organized in the tree structure shown in the virtual folder structure information.

This operation allows the classifying unit 113 to hierarchically create folders on the HDD 103 when the categories indicated in the additional information are hierarchically classified. As a result, the accessibility to the user's desired image file will improve.

### 6. Other Embodiments

The present invention shall not be limited to the above Embodiment; instead other Embodiments may be available to introduce the present invention. Hereinafter, the other Embodiments are exemplified.

In changing the category of an image file, Embodiment introduces a technique to drag and drop a desired image (for example, the image A-1) onto a folder of a desired category (for example, [01-a] Osaka). In this operation, the virtual folder structure information is updated as well.

Concurrently, for example, the user may click the desired folder (for example, [01-a] Osaka) to change the name of the folder, so that the set name can be any given name different from a folder name which is based on the additional information of the image file.

In other words, the name of a virtual folder may differ from a category name indicated in any additional information of the image files. The name of a virtual folder may be changed according to a command of the user.

In addition, the virtual folder may be added or deleted according to the user's command. Specifically, a category may be added or deleted in the virtual folder structure according to the user's command.

Furthermore, the additional information on each image files may be entered using the mouse 104 and the keyboard 105. In other words, the classifying unit 113 may generate or update additional information on at least one image file according to a command which the receiving unit 111 receives.

Consider the case as described above where the user gives a command to execute the following in the virtual folder structure: to change a category name, to add or delete a category, or to generate or update additional information. Here the classifying unit 113 may update the virtual folder structure information according to the command.

When the virtual folder structure information is updated; that is, for example, when the user selects the synchronization button 203, the above synchronous operation may be executed so that the updated virtual folder structure information is reflected in the actual folder structure.

When the classifying unit 113 adds a new category to the virtual folder structure information, for example, the control unit 114 may cause the recording unit 115 to create on the HDD 103 a new folder corresponding to the new category.

When the user provides any given name to a category or adds a category, in general, the image file corresponding to the category is mostly the one that the user especially desires to distinguish the image file from other image files.

Thus the accessibility improves when the user views his or her desired image file by allowing the user to (i) change the category name or to add a category on the editing window, and (ii) generate or update the additional information.

When the classifying unit 113 deletes a category from the virtual folder structure information, the control unit 114 may cause the recording unit 115 to delete a folder corresponding to the deleted category.

It is noted that when the folder is to be deleted, an image file stored in the folder may be moved to a folder named “Deleted” for example.

When a new image file is added to a folder (for example, the folder A-1) displayed in the target fold structure displaying area 200, for example, the virtual folder structure information may be updated according to additional information on the new image file, and a synchronous operation may be executed.
Here the obtaining unit 112 obtains the new image file, and the classifying unit 113 updates the virtual folder structure information using the additional information on the new image file.

When a new category is added to the virtual folder structure information by the update, the control unit 114 causes the recording unit 115 to create a new folder corresponding to the new category on the HDD 103, and to record the new image file to the new folder.

In the PC 100 according to Embodiment, the synchronous operation is executed when the synchronization button 203 is selected; concurrently, the synchronous operation may be executed in a timed relationship other than that with the selection. For example, the synchronous operation may be executed for each predetermine time period or at an update of the virtual folder structure information.

Furthermore, the PC 100 may execute the synchronous operation on image files recorded on, for example, an external recording unit instead of the HDD 103. In other words, the PC 100 may generate the virtual folder structure information based on additional information on the image files recorded on the external recording unit. According to the virtual folder structure information, the PC 100 may create two or more folders and store the image files in the folders.

In Embodiment, the PC 100 classifies image files. Concurrently, the PC 100 can classify various kinds of content files, including a music file and an executable file of a game.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The present invention relates to content file classifying apparatuses and, in particular, to a content file classifying apparatus capable of recording content files on a recording medium. In other words, the present invention is applicable to an electronic devices which can record content files on a recording medium, such as a video, a cellular phone, and a digital camera, as well as applicable to a PC. Furthermore, the present invention may be introduced in a form of (i) a program executable a function similar to that of the above electronic device, and (ii) recording media including Compact Disk (CD) and a Digital Versatile Disk. (DVD) which record the program.

What is claimed is:

1. A content file classifying apparatus comprising:
an obtaining unit configured to obtain content files;
a classifying unit configured to generate, based on additional information on each of the content files obtained by said obtaining unit, classification information showing a category to which each content file belongs;
a control unit configured to control recording of the content files on a recording medium; and
a recording unit configured to record each of the content files on the recording medium according to the control by said control unit,
wherein said control unit is configured to cause said recording unit to (i) create, on the recording medium, folders corresponding to categories shown in the classification information generated by said classifying unit, and (ii) record each of the content files in at least one of the folders corresponding to a category to which the content file belongs.

2. The content file classifying apparatus according to claim 1,
wherein said classifying unit is configured to generate the classification information showing a tree structure constructed of the categories based on the additional information on each of the content files, and
said control unit is configured to cause said recording unit to create the folders so that the folders are organized in the tree structure shown in the classification information.

3. The content file classifying apparatus according to claim 1,
wherein, when receiving a predetermined command for generating the folders, said control unit is configured to cause said recording unit to (i) create the folders on the recording medium, and (ii) record each of the content files in at least one folder, from among the folders, corresponding to a category to which the content file belongs.

4. The content file classifying apparatus according to claim 1,
wherein said classifying unit is configured to generate or update the additional information on at least one of the content files according to a command which said classifying unit receives.

5. The content file classifying apparatus according to claim 1,
wherein said classifying unit is further configured to update the classification information according to a command which said classifying unit receives, and
when said classifying unit adds a new category to the classification information, said control unit is further configured to cause said recording unit to create, on the recording medium, a new folder corresponding to the new category.

6. The content file classifying apparatus according to claim 1,
wherein said classifying unit is further configured to update the classification information according to a command which said classifying unit receives, and
when said classifying unit deletes a category from the classification information, said control unit is further configured to cause said recording unit to delete a folder corresponding to the deleted category.

7. The content file classifying apparatus according to claim 1,
wherein said classifying unit is further configured to update the classification information according to a command which said classifying unit receives, and
when said classifying unit deletes a category from the classification information, said control unit is further configured to cause said recording unit to move one or more content files, stored in a folder corresponding to the deleted category, from the folder to an other folder.

8. The content file classifying apparatus according to claim 1,
wherein said classifying unit is further configured to update the classification information according to a command which said classifying unit receives, so that one of the content files corresponds to an other category which differs from a category shown in additional information on the one content file, and
said control unit is further configured to cause said recording unit to record the one content file in a folder corresponding to the other category according to the updated classification information.

9. The content file classifying apparatus according to claim 1,
wherein said obtaining unit is further configured to obtain a new content file,
said classifying unit is further configured to update the classification information using additional information on the new content file, and
when said classifying unit adds a new category to the classification information, said control unit is further configured to cause said recording unit to (i) create, on the recording medium, a new folder corresponding to the new category, and (ii) record the new content file in the new folder.

10. The content file classifying apparatus according to claim 1,
wherein said obtaining unit is configured to obtain the content files which have been found in the recording medium before said control unit creates the folders.

11. The content file classifying apparatus according to claim 1,
wherein, when one of the content files belongs to two or more categories shown in the classification information, said control unit is configured to cause said recording unit to record the one content file in each of two or more folders corresponding to the two or more categories.

12. A method for classifying content files, said method comprising: obtaining the content files;
generating, based on additional information on each of the content files obtained in said obtaining, classification information showing a category to which each content file belongs;
creating, on a recording medium, folders corresponding to categories shown in the classification information generated in said generating, and
recording each of the content files in at least one of the folders corresponding to a category to which the content file belongs.

13. A program product which is recorded on a non-transitory computer-readable recording medium, and which allows a computer to execute:
obtaining content files;
generating, based on additional information on each of the content files obtained in said obtaining, classification information showing a category to which each content file belongs;
creating, on a recording medium, folders corresponding to categories shown in the classification information generated in said generating, and
recording each of the content files in at least one of the folders corresponding to a category to which the content file belongs.

14. An integrated circuit comprising:
an obtaining unit configured to obtain content files;
a classifying unit configured to generate, based on additional information on each of the content files obtained by said obtaining unit, classification information showing a category to which each content file belongs;
a control unit configured to control recording of the content files on a recording medium; and
a recording unit configured to record each of the content files on the recording medium according to the control by said control unit,
wherein said control unit is configured to cause said recording unit to (i) create, on the recording medium, folders corresponding to categories shown in the classification information generated by said classifying unit, and (ii) record each of the content files in at least one of the folders corresponding to a category to which the content file belongs.
